(19) United States
(12) Patent Application Publication
(10) Pub. No.: US 2007/0240579 A1
(43) Pub. Date: Oct. 18, 2007

(54) Composite barrel

(76) Inventor: Brian G. Boake, North York (CA)

Correspondence Address: STRAUB & POKOTYLO, 620 TINTON AVENUE, BLDG. B, 2ND FLOOR, TINTON FALLS, NJ, 07724, US

(21) Appl. No.: 11/405,837

(22) Filed: Apr. 18, 2006

(51) Int. Cl. C12G 3/06

(52) U.S. Cl. 99/277.1

(57) ABSTRACT

A composite barrel for storing wine comprising a polymer body, at least one removable wooden head for attachment to an end of the polymer body, each wooden head having an interior surface, the interior surface configured to increase the surface area of the interior surface of the wooden head for contact with wine to be stored, and a sealing mechanism for sealingly securing each removable wooden head to the polymer body. A wooden head may be used at both ends of the barrel for sealing the barrel and bringing more wood into contact with the contents of the barrel.

### TECHNICAL FIELD

The present invention relates to composite barrels for storing liquids such as wine, spirits and the like.

### BACKGROUND

Wine barrels and in particular oak wine barrels have been used as receptacles for storing and ageing wine during the wine making process. When wine is stored in a wooden barrel, particularly oak, a tannin flavor is imparted by wood phenolics to the wine. This enrichment generally improves the quality of the wine. It is therefore generally considered desirable to age wine in an oak receptacle to impart sought-after characteristics into the wine.

However, oak barrels are increasingly expensive to purchase and maintain. Their high cost is at least partly due to the fact that their construction can require staves that are generally made from boards taken from the most valuable parts of the oak trees as well as skilled coopers required to make and repair the barrels. Construction of a typical 59 gallon wine barrel requires the consumption of two full oak trees, each one at least approximately one hundred years old.

With continuous use of wooden wine barrels over extended periods, the inner surfaces of the barrel becomes contaminated with wine residue and the much sought-after wood flavor becomes less and less available. As a result, oak wines barrels impart varying sensory characteristics to the wine according to the age of the barrel, making reproducibility from batch to batch difficult.

Further, oak wine barrels when not in use are subject to attack by certain types of bacteria or fungi and frequently must be treated with suitable chemicals to avoid any serious contamination. Accordingly, it is sometimes necessary to discard not only used barrels, but contaminated wooden wine barrels as well, since chemical treatments are sometimes ineffective and can alter the taste of the wine.

### SUMMARY

Certain exemplary embodiments can provide a composite barrel for storing a liquid, the composite barrel comprising: a polymer body having an open end; a wooden head attachable to the open end of the polymer body, the wooden head having an interior surface configured to increase surface area for contact with the liquid and an exterior surface; and a sealing mechanism for sealingly securing the wooden head to the polymer body.

Certain exemplary embodiments can provide a wooden head for use with a composite barrel for storing a liquid, the wooden head comprising an interior surface contactable with the liquid and an exterior surface; and a plurality of channels formed on the interior surface to increase surface area for contact with the liquid.

### BRIEF DESCRIPTION OF THE DRAWINGS

FIG. 1 is an exploded view illustrating an exemplary embodiment of various components of a composite barrel;

FIG. 2 is an isometric view of an exemplary embodiment of an outer ring of the composite barrel;

FIG. 3A is an isometric view of an exemplary embodiment of a wooden head of the composite barrel;

FIG. 3B is a cross-sectional view of the wooden head of FIG. 3A;

FIG. 4 is an isometric view of an exemplary embodiment of an inner ring of the composite barrel of FIG. 1;

FIG. 5 is a cross-sectional view of an exemplary embodiment of a wooden head installed on a composite barrel;

FIG. 6A is an underside (interior surface) elevation view of an embodiment of a wooden head illustrating an example of the configured interior surface;

FIG. 6B is a cross-sectional view of the wooden head of FIG. 6B;

FIG. 7A is an underside (interior surface) elevation view of another embodiment of a wooden head illustrating another example of the configured interior surface

FIG. 7B is a cross-sectional view of the wooden head of FIG. 7B;

FIG. 8A is an underside (interior surface) elevation view of another embodiment of a wooden head illustrating another example of the configured interior surface; and

FIG. 8B is a cross-sectional view of the wooden head of FIG. 8A.

### DETAILED DESCRIPTION

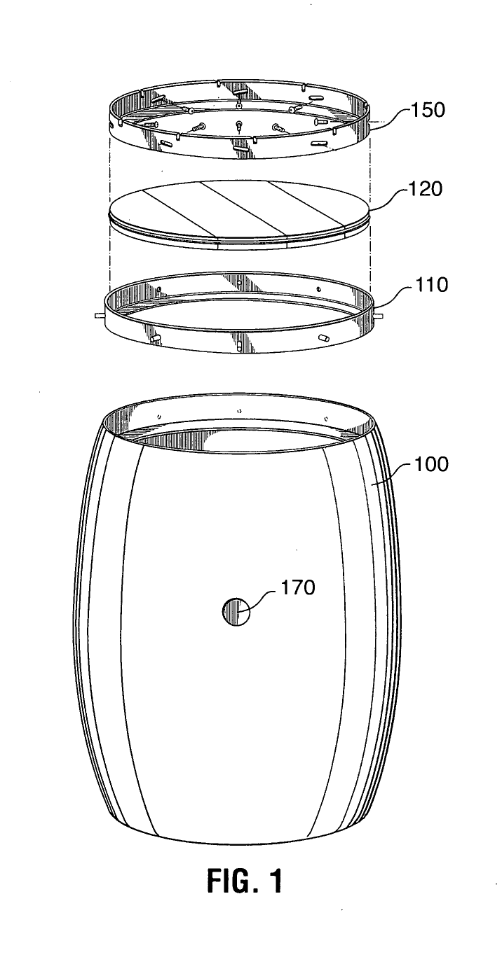

FIG. 1 illustrates an embodiment of a composite barrel for storing wine or other alcohol or liquid products shown in exploded view. The composite barrel comprises a polymer body 100, an outer ring 110, a wooden head 120 and an inner ring 150.

The polymer body 100 may be made of food grade plastic or other plastics suitable for contact with liquid for consumption including polymers and copolymers. The polymer body 100 may be made of rotomolded plastic, a plastic casting or by other methods. The polymer body 100 may comprise additional structural members or elements such as longitudinal or lateral ridges, bulges or other strengthening members for imparting strength to the barrel. The polymer body 100 may also include other aesthetic features or shapes as desired and may be made to resemble the shape or appearance of a typical wine barrel.

The wooden head 120 has an interior surface for contact with the contents of the barrel, for example wine. The wooden head 120 can impart various characteristics to the contents of the barrel depending on the type of wood and other factors. The wooden head 120 can, for example, impart tannin to the contents of the barrel. The interior surface is configured to increase the surface area in potential contact with the contents of the barrel thereby bringing more wood into contact with the contents of the barrel. In this way, more characteristics of the wood of the wooden head 120, such as tannin, may be imparted into the contents of the barrel as compared to a non-configured wooden head.

This may be controlled or manipulated based on, for example, the type of wood (e.g., oak and cherry), the age of the wood, the thickness the wood, the size of the surface area of wood in contact with the contents of the barrel, etc. Moreover, the configuration of the interior of the wooden head 120 may be selected based on the desired amount of contact one wishes to have between the contents of the barrel and the wooden head 120. In addition, oxygenation of the contents of the barrel may take place through the wooden head 120 and may also be controlled based on, for example, the type of wood, the age of the wood, the thickness the wood, the size of the surface area of wood in contact with the contents of the barrel, etc.

The outer ring 110 fits within a flange on the end of the polymer body 100 and is adapted to seat the wooden head 120.

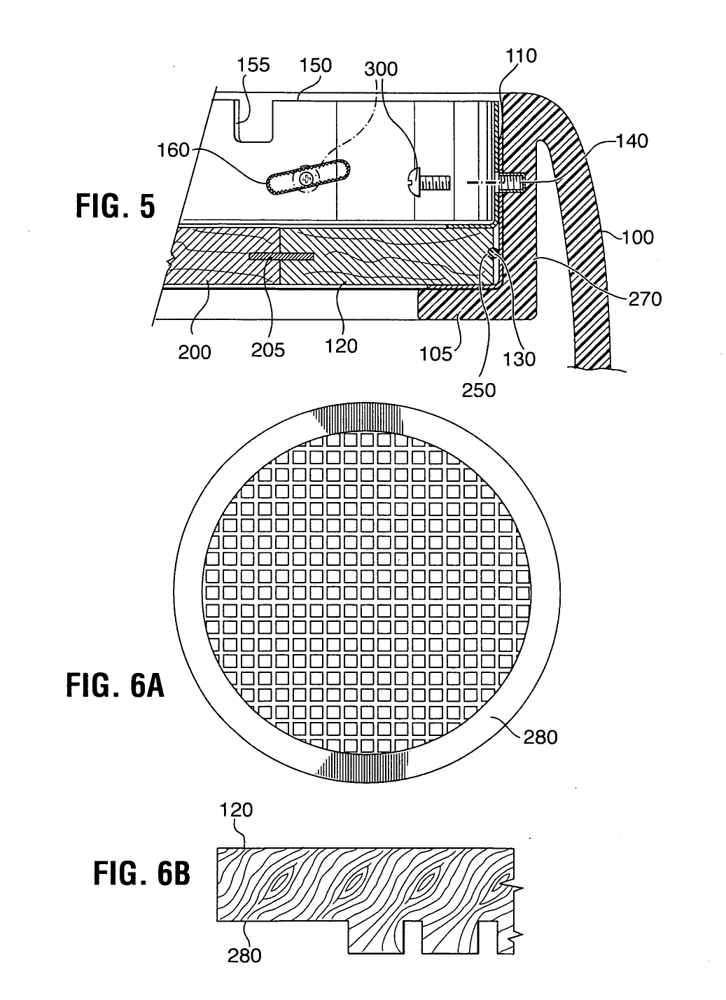

The inner ring 150 nests within and releasably locks to the outer ring 110 and secures the wooden head 120 to the polymer body 100, as will be shown in more detail below with reference to FIG. 5.

Although an outer ring 110 and an inner ring 150 are illustrated having an attaching mechanism for securing the wooden head 120 to the polymer body 100, other attaching mechanisms may be utilized provided that sealed attachment of the wooden head 120 to the polymer body 100 is achievable. Other types of attachment mechanisms can include a friction fit, an interference fit, threaded attachment of the wooden head 120 to the polymer body 100, adhesive attachment, a welded attachment, etc.

By utilizing a polymer body 100 in construction of the barrel in place of oak staves it is unnecessary to cultivate trees for use in the manufacture of the staves and the services of a cooper are not required. This can result in a cost savings over a standard oak wine barrel. Furthermore, the wooden head 120 may be made from discarded or previously used wood that can be recycled or reconditioned for use in the composite barrel. The wooden head 120 may be made from a series of planks expandable when soaked to thereby strengthen the seal between the polymer body 100, the inner ring 150 and the outer ring 110. The planks may be quarter sawn for more predictable expansion and contraction. As a result of using smaller planks joined to form the wooden head 120, wood may be used having a smaller cross-section or diameter thereby allowing for smaller trees to be cultivated and further reducing costs of the manufacture of the barrel and the wooden head 120. Manufacturing cost can be further reduced by utilizing recycled or reconditioned wood.

The interior surface of the wooden head 120 for contact with the contents of the barrel is configured to increase the surface area relative to a flat surface or non-configured surface. By increasing the surface area of wood for contact with the contents of the barrel, more characteristics of the wood may be imparted to the contents of the barrel. In practice, a completely wooden barrel may be simulated as desired. Alternatively, various patterns of configured interior surface may be used to increase the surface area of the wooden head from about 1% to over 100%. Various patterns of configured interior surface may be chosen depending on the desired characteristics of the contents of the barrel.

If a reproducible pattern is used to increase the surface area of the interior surface of the wooden head 120, the wooden head may be replaced with a replacement wooden head having an identical surface area thereby allowing for the same characteristics to be imparted to the contents of the barrel. This allows for improved reproducibility between batches of wine even when the wooden head 120 is replaced. When viewed in combination with the lower replacement cost of the heads, this means that the wooden head 120 may be replaced more often with one of substantially identical interior surface area allowing for reproducible wine or other spirits or contents at a lower cost.

The polymer body 100 may further include a bung hole 170 for receiving a bung. This allows for, among others, monitoring of the contents of the barrel as well as the status of the interior of the barrel including the interior surface of the wooden head 120. Once it has been determined that the interior surface of the wooden head 120 is occluded, dirty, depleted, broken down, or requires replacement, a replacement wooden head may be installed on the polymer body 100, optionally having an identically configured pattern on the interior surface.

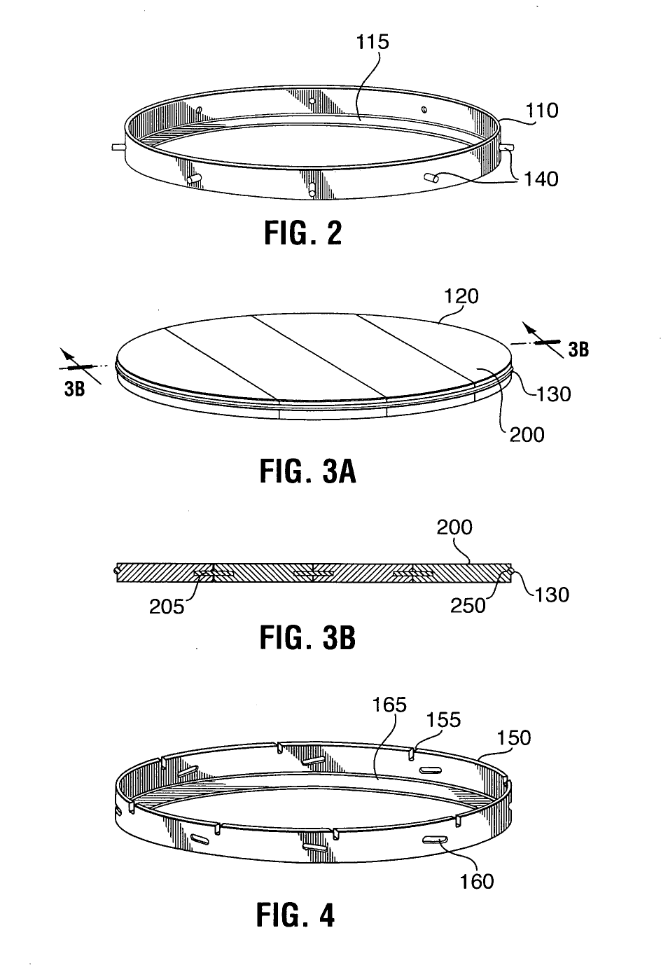

FIG. 2 illustrates an embodiment of the outer ring 110 for seating the wooden head 120. The outer ring 110 is adapted to sealingly fit within a flange of the polymer body 100 of the composite barrel. The outer ring 110 comprises a series of connectors 140 for securing the outer ring 110 to the polymer body 100. The connectors 140 may be a rivet or rivet like connector or may be any other suitable connector for securing the outer ring 110 to the polymer body 100, either during manufacture, for example during rotomolding of the polymer body 100, or post manufacture.

The outer ring 110 may be positioned during manufacture of the polymer body 100, for example during rotomolding of the polymer body 100 such that on completion of the rotomold, the outer ring 110 is situated in place and secured by the connectors 140. The internal edge of the connectors 140 is substantially flush with the interior surface of the outer ring 110 allowing for passage of the wooden head 120. Each connector 140 has an internal bore for receiving a fastener, such as a pin, a screw or the like. The outer ring 110 may have an internal annular lip 115 for seating the wooden head 120. Alternatively, if the outer ring 110 does not have an internal annular lip 115, the polymer body 100 may have an annular lip upon which the wooden head is seated. Alternatively, the outer ring 110 and the polymer body 100 may both have a lip upon which the wooden head 120 is seated as will be shown with reference to FIG. 5.

FIGS. 3A and 3B illustrate an embodiment of a wooden head 120. The wooden head 120 is comprised of a series of planks 200 connected for example using tongue and groove, mortise and tenon joins or, as illustrated in FIG. 3B, using one or more splines 205 to join neighboring planks 200 together. The planks 200 may be selected such that they expand when wetted. Expansion of the planks 200 after assembly secures the join between the planks 200 and reinforces the seal between the wooden head 120, the outer ring 110 and the polymer body 100. The planks 200 may be quarter sawn so that their expanding and contracting behavior is more predictable. Removal of the wooden head 120 may be done by either breaking the wooden head 120 once it has lost the ability to consistently impart characteristics to the contents of the barrel or by drying the wooden head 120 thereby contracting the wood and allowing removal.

The wooden head 120 may further comprise an annular seal 130 that may be seated in an annular groove 250 in the wooden head 120. The annular seal 130 presses against the interior surface of the outer ring 110 sealing the wooden head 120 and the outer ring 110 from egress of the contents of the barrel. The annular seal 130 may be selected from, for example, an O-ring or a gasket.

FIG. 4 illustrates the inner ring 150 for use with the wooden head 120 and the outer ring 110 as shown for example in FIG. 1. The inner ring 150 nests within the outer ring 110 and adjacent the wooden head 120. When secured to the outer ring 110 or the polymer body 100, the inner ring 150 applies a force to the wooden head 120 and sealingly secures the wooden head 120 to the polymer body 100 and/or the outer ring 110. The inner ring 150 may be secured to the outer ring 110 by various means. The inner ring 150 may comprise a hole for communication with the connector 140 of the outer ring 110 through which a fastener 300 (as shown in FIG. 5) such as a pin or screw may be used for insertion into the internal bore of the rivet 140.

The inner ring 150 may comprise a slanted slot 160 for communication with the connector 140 of the outer ring 110. The slanted slot 160 is slanted such that after insertion of a fastener 300 through the slanted slot 160 and into the internal bore of the connector 140, rotation of the inner ring 150 in one direction shifts the inner ring 150 towards the wooden head 120 thereby imparting a sealing force against the wooden head 120 further strengthening the seal between the polymer body 100, the outer ring 110 and the wooden head 120. The slanted slot 160 may have sections along its perimeter that are scalloped or serrated to aid in gripping the fastener 300 inserted therethrough. The slanted slot 160 may alternatively be completely free of scalloped or serrated sections or may be fully scalloped or serrated.

To distribute the force imparted by the inner ring 150 against the wooden head 120, the inner ring 150 further comprises an annular interior lip 165 adapted to press against the wooden head 120 when the inner ring 150 is nested in the outer ring 110.

To aid in rotating the inner ring 150, the inner ring 150 may comprise one or more notches 155 for interface with a tool, either manually operated or automated, for rotating the inner ring 150.

FIG. 5 shows a cross-section of an embodiment of an attachment mechanism for securing the wooden head 120 to the polymer body 100. The polymer body 100 has an annular flange 270 for receiving the outer ring 110. The outer ring 110 is secured to the polymer body 100 by a connector 140. The connector 140 may be imbedded into the polymer body 100 after manufacture of the body or alternatively, the connector 140 and the outer ring 110 may be placed in the polymer body 100 during manufacture of polymer body 100 for example during rotomolding of the polymer body 100. The connector 140 has an exterior head which is substantially flush with the outer ring 110 such that a wooden head 120 can pass by the connector 140 for seating in the outer ring 150. The outer ring 110 optionally comprises an interior annular lip 115 on which the wooden head 120 is seated.

The annular flange 270 also comprises an optional annular lip 105 for further reinforcing, securing and/or supporting the outer ring 110 and the wooden head 120. Once the wooden head 120 is seated on the outer ring 110, an inner ring 150 is nested in the outer ring 110 and may be secured in place using a fastener 300 in connection with the connector 140 which has an internal bore for receiving the fastener 300. If the inner ring 150 comprises slanted slots 160 (as shown in FIG. 4), the inner ring 150 may be rotated thereby imparting pressure against the wooden head 120 and sealingly securing the wooden head 120 to the outer ring 110 and the polymer body 100. The wooden head 120 is comprised of planks 200 connected by splines 205. The wooden head 120 further comprises an annular seal 130 for sealing the connection between the wooden head 120 and the outer ring 110.

Wetting the wooden head 120 after seating in the outer ring 110 may be done to expand the wooden head 120 and increase the strength of the seal between the wooden head 120 and the polymer body 100. In order to facilitate this technique, the planks 200 of the wooden head 120 may be quarter sawn so that the expansion of the planks is more predictable.

Although a typical flange 270 and annular lip 105 are illustrated in FIG. 5, it should be understood that many shapes (for the flange and/or polymer body) are supported provided that a sealing connection can be obtained between the outer ring 110 and the polymer body 100. Furthermore, the flange 270 may be incorporated into the shape of the polymer body 100 and need not be an inner annular flange depending from an upper edge of the polymer body 100.

The fasteners 300 of the embodiment illustrated in FIG. 5 may be any fasteners provided that secured retention of the inner ring 150 to either the outer ring 110 and/or the polymer body 100 may be carried out. For example, the fasteners may be a pin, screw, etc.

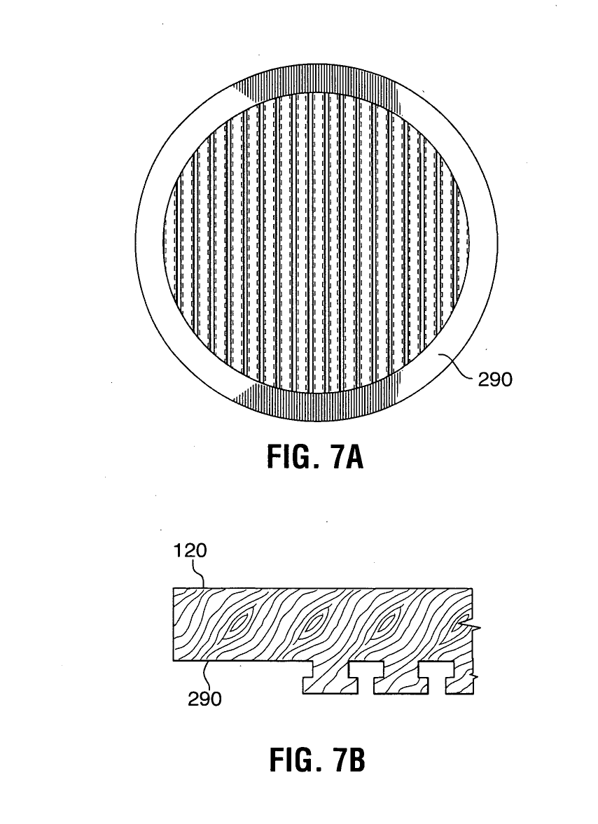

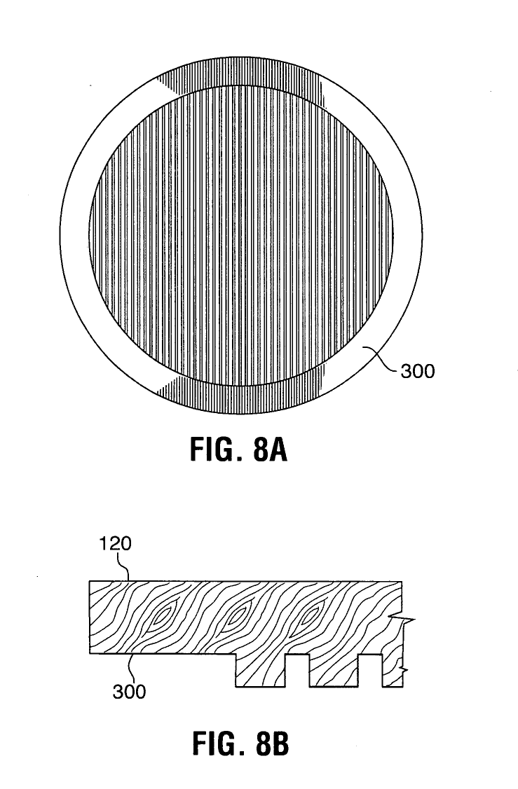

FIGS. 6A, 7A and 8A (elevation views) and FIGS. 6B, 7B and 8B (respective cross-section views) illustrate various configurations of the interior surface of the wooden head 120. In FIG. 6A the interior surface 280 of the wooden head 120 has been configured to increase the surface area for contact with the contents of the composite barrel. A cross-hatch channel pattern is used to increase the surface area for contact with the contents of the composite barrel by between about 17% and about 37.5%. In FIG. 7A the interior surface 290 of the wooden head 120 has been configured with a linear pattern of T-shaped channels to increase the surface area for contact with the contents of the composite barrel by between about 17% and about 46%. In FIG. 8A the interior surface 300 of the wooden head 120 has been configured with a linear pattern of U-shaped channels to increase the surface area for contact with the contents of the composite barrel by between about 17% and about 114%. Details of the structure and surface area calculations are provided below in Tables I-a to I-f. It will be understood that any pattern may be used to increase the interior surface area of the wooden head 120 for contact with the contents of the barrel. The pattern may be reproducible, or non-reproducible, i.e. hand performed.

Furthermore, the exterior surface of the wooden head 120 may also be configured to increase the surface area so that simply turning over the wooden head 120 exposes a fresh or unblemished surface for contact with the contents of the barrel.

Although the FIGS. 1-5 illustrate a composite barrel having a wooden head 120 at one end, it should be understood that each end of the composite barrel may have a wooden head 120. Each wooden head 120 of the composite barrel may have articulations selected independently of each other and may therefore be the same or different from each other.

Various embodiments provide for a composite barrel comprising a polymer body and at least one replaceable wooden head. The replaceable wooden head has an interior surface for contact with the contents of the barrel that is configured to increase the surface area and thereby increase the amount of wood characteristics, such as tannin, which may be imparted into the wine. Oxygenation of the contents of the barrel may occur through the wooden head. The replaceable wooden head consumes less wood than a typical oak barrel thereby lowering replacement costs. The interior surface of the replaceable wooden heads may be monitored throughout the storage of the contents of the barrel to watch for occlusion, break down of the wood and the like. The surface area of the interior surface of the wooden head may be reproducible allowing for a consistent amount of wood contact with the stored contents and consistent oxygenation between replacement of the wooden heads. The composite or polymer nature of the composite barrel body further minimizes absorption of spilt wine and bacteria growth and/or insect contamination as a result.

In one variation of the composite barrel, a stainless steel sleeve is inserted into the polymer body 100 of the barrel for contact with the contents of the barrel. The stainless steel sleeve may either completely or partially cover the interior surface of the polymer body 100.

It is apparent to one skilled in the art that numerous modifications and departures from the specific embodiments described herein may be made without departing from the spirit and scope of the invention.

TABLE I-a

| | SUMMARY | | | |
|---|---|---|---|---|
| | (All Measures in Square Inches) | | | |
| | | | Total 2 | % Surface |
| | Head 1 | Head 2 | Heads | Area |
| Barrel Head/Flat | 380.1327 | 380.1327 | 760.2654 | 20.27% |
| Surface Area = | | | | |
| 760.2654/3451.0154 | | | | |
| Cross-Hatched FIG. 6A | 846.6327 | 846.6327 | 1693.2654 | 45.14% |
| T-Channeled ½″ | 819.6300 | 819.6300 | 1639.2600 | 43.70% |
| FIG. 7A - Option 1 | | | | |
| T-Channeled 1″ - | 1039.3800 | 1039.3800 | 2078.7600 | 55.42% |
| FIG. 7A - Option 2 | | | | |
| U-Channeled ½″ | 1259.1327 | 1259.1327 | 2518.2654 | 67.14% |
| FIG. 8A - Option 1 | | | | |
| U-Channeled 1″ - | 2138.1327 | 2138.1327 | 4276.2654 | 114.00% |
| FIG. 8A - Option 2 | | | | |
| Plastic Surface Area | | | 3751.0000 | |
| Full Barrel Surface = | | | 4511.2654 | |
| 760.2654 + 3451.01 | | | | |

TABLE I-b
FIG. 6A

| | | | Total 2 | % Surface |
|---|---|---|---|---|
| | Head 1 | Head 2 | Heads | Area |
| Cross-Hatched Channel | | | | |
| Pattern - Area of | | | | |
| each Cube - .75 × .50 × | 1.5000 | | | |
| 4 Sides | | | | |
| Number of Cubes per | 311.0000 | | | |
| Surface | | | | |
| Total Area of all Cubes' | | | 466.5000 | |
| 4 Sides | | | | |
| Area of Head (Flat | | | | |
| Surface) = Pi R2, | | | | |
| Therefore 3.1415927 × | | | 380.1327 | |
| 11*11 | | | | |
| Total of Cross-Hatched | | | | |
| Area + Total Flat | | | | |
| Head | | | 846.6327 | |
| Increase in Head Area | | | | |
| Through Articulation = | | | | |
| 466.50/380.1327 | 122.72% | 122.72% | | 245.44% |

TABLE I-c
FIG. 7A - OPTION 1 - ½″
13 Routered Channels - Routered at a Depth of ½″
per Head (A thru M)

| | | | | Total | |
|---|---|---|---|---|---|
| Area per T-Shaped Channel @ ½″ = 2″ where | | # of | | Area for | % Surface |
| (A = .25″ & B = .25″ & C = .5″) × 2 = 2 | Length | Halves | Area | 1 Head | Area |
| Channel A | 11.25 | 1 | 2 | 22.5 | |
| Channel B | 6.75 | 2 | 2 | 27 | |
| Channel C | 8.625 | 2 | 2 | 34.5 | |
| Channel D | 9.75 | 2 | 2 | 39 | |
| Channel E | 9.75 | 2 | 2 | 39 | |
| Channel F | 9.75 | 2 | 2 | 39 | |
| Channel G | 9.75 | 2 | 2 | 39 | |
| Channel H | 9.75 | 2 | 2 | 39 | |
| Channel I | 9.75 | 2 | 2 | 39 | |
| Channel J | 9.25 | 2 | 2 | 37 | |
| Channel K | 8.5 | 2 | 2 | 34 | |
| Channel L | 7 | 2 | 2 | 28 | |
| Channel M | 11.25 | 1 | 2 | 22.5 | |
| Total Area per Head | | | | 439.50 | |
| Area of Head (Flat Surface) = Pi R2, Therefore | | | | | |
| 3.1415927 × 11*11 | | | | 380.1327 | |
| Total of T-Channeled Area + Total Flat Head | | | | 819.63 | |
| Option 1 Increase in Head Area Through Articulation = | | | | | |
| 439.5/380.1327 | | | | 115.62% | |
| % Oak to Plastic for 1 Head = 819.63/3751 | | | | | 21.85% |
| % Oak to Plastic for 2 Heads = 1639.26/3751 | | | | | 43.70% |

TABLE I-d
FIG. 7A - OPTION 2 - 1″
13 Routered Channels - Routered at a Depth of 1″
per Head (A thru M)

| Area per T-Shaped Channel @ 1″ = 3″ where | | # of | | Total Area | % Surface |
|---|---|---|---|---|---|
| (A = .25″ & B = .25″ & C = 1″) × 2 = 3 | Length | Halves | Area | for 1 Head | Area |
| Channel A | 11.25 | 1 | 3 | 33.75 | |
| Channel B | 6.75 | 2 | 3 | 40.5 | |
| Channel C | 8.625 | 2 | 3 | 51.75 | |
| Channel D | 9.75 | 2 | 3 | 58.5 | |
| Channel E | 9.75 | 2 | 3 | 58.5 | |
| Channel F | 9.75 | 2 | 3 | 58.5 | |
| Channel G | 9.75 | 2 | 3 | 58.5 | |
| Channel H | 9.75 | 2 | 3 | 58.5 | |
| Channel I | 9.75 | 2 | 3 | 58.5 | |
| Channel J | 9.25 | 2 | 3 | 55.5 | |
| Channel K | 8.5 | 2 | 3 | 51 | |
| Channel L | 7 | 2 | 3 | 42 | |
| Channel M | 11.25 | 1 | 3 | 33.75 | |
| Total Area per Head | | | | 659.25 | |
| Area of Head (Flat Surface) = Pi R2, | | | | | |
| Therefore 3.1415927 × 11*11 | | | | 380.1327 | |
| Total of T-Channeled Area + Total Flat Head | | | | 1039.38 | |
| Option 1 Increase in Head Area Through | | | | | |
| Articulation = 659.25/380.1327 | | | | 173.43% | |
| % Oak/Plastic for 1 Head = 1039.38/3751 | | | | | 27.71% |
| % Oak/Plastic/2 Heads = 2078.76/3751 | | | | | 55.42% |

TABLE I-e
FIG. 8A - OPTION 1 - ½″
26 Routered Channels Routered at a Width of .125 and Depth of ½″
per Head (A thru M)

| Area per U-Shaped Channel @ ½″ = 1″ where | | # of | | Total Area | % Surface |
|---|---|---|---|---|---|
| (C = .5″) × 4 = 2″ | Length | Halves | Area | for 1 Head | Area |
| Channel A | 11.25 | 2 | 2.00 | 45 | |
| Channel B | 6.75 | 4 | 2.00 | 54 | |
| Channel C | 8.625 | 4 | 2.00 | 69 | |
| Channel D | 9.75 | 4 | 2.00 | 78 | |
| Channel E | 9.75 | 4 | 2.00 | 78 | |
| Channel F | 9.75 | 4 | 2.00 | 78 | |
| Channel G | 9.75 | 4 | 2.00 | 78 | |
| Channel H | 9.75 | 4 | 2.00 | 78 | |
| Channel I | 9.75 | 4 | 2.00 | 78 | |
| Channel J | 9.25 | 4 | 2.00 | 74 | |
| Channel K | 8.5 | 4 | 2.00 | 68 | |
| Channel L | 7 | 4 | 2.00 | 56 | |
| Channel M | 11.25 | 2 | 2.00 | 45 | |
| Total Area per Head | | | | 879.0000 | |
| Area of Head (Flat Surface) = Pi R2, Therefore | | | | | |
| 3.1415927 × 11*11 | | | | 380.1327 | |
| Total of U-Channeled Area + Total Flat Head | | | | 1259.1327 | |
| Option 1 Increase in Head Area Through | | | | | |
| Articulation = 439.5000/380.1327 | | | | 231.24% | |
| % Oak to Plastic for 1 Head = 819.6327/3751 | | | | | 33.57% |
| % Oak to Plastic for 2 Heads = 1639.2654/3751 | | | | | 67.14% |

TABLE I-f
FIG. 8A - OPTION 2 - 1″
26 Routered Channels - Routered at a Width of .125 and Depth of 1″
per Head (A thru M)

| Area per U-Shaped Channel @ 1″ = 2″ where | | # of | | Total Area | % Surface |
|---|---|---|---|---|---|
| (C = 1″) × 4 = 4″ | Length | Halves | Area | for 1 Head | Area |
| Channel A | 11.25 | 2 | 4.00 | 90.00 | |
| Channel B | 6.75 | 4 | 4.00 | 108.00 | |
| Channel C | 8.625 | 4 | 4.00 | 138.00 | |
| Channel D | 9.75 | 4 | 4.00 | 156.00 | |
| Channel E | 9.75 | 4 | 4.00 | 156.00 | |
| Channel F | 9.75 | 4 | 4.00 | 156.00 | |
| Channel G | 9.75 | 4 | 4.00 | 156.00 | |
| Channel H | 9.75 | 4 | 4.00 | 156.00 | |
| Channel I | 9.75 | 4 | 4.00 | 156.00 | |
| Channel J | 9.25 | 4 | 4.00 | 148.00 | |
| Channel K | 8.5 | 4 | 4.00 | 136.00 | |
| Channel L | 7 | 4 | 4.00 | 112.00 | |
| Channel M | 11.25 | 2 | 4.00 | 90.00 | |
| Total Area per Head | | | | 1758.00 | |
| Area of Head (Flat Surface) = Pi R2, | | | | | |
| Therefore 3.1415927 × 11*11 | | | | 380.1327 | |
| Total of U-Channeled Area + Total Flat Head | | | | 2138.1327 | |
| Option 1 Increase in Head Area Through | | | | | |
| Articulation = 879/380.1327 | | | | 462.47% | |
| % Oak/Plastic for 1 Head = 1259.32/3751 | | | | | 57.00% |
| % Oak/Plastic/2 Heads = 2518.64/3751 | | | | | 114.00% |

1. A composite barrel for storing a liquid, the composite barrel comprising:
a polymer body having an open end;
a wooden head attachable to the open end of the polymer body, the wooden head having an interior surface configured to increase surface area for contact with the liquid and an exterior surface; and
a sealing mechanism for sealingly securing the wooden head to the polymer body.

2. The composite barrel of claim 1, wherein interior surface of the wooden head comprises a region of channels.

3. The composite barrel of claim 2, wherein the region of channels comprises cross-hatch channels formed in the interior surface of the wooden head.

4. The composite barrel of claim 2, wherein the region of channels comprises linear T-channels formed in the interior surface of the wooden head.

5. The composite barrel of claim 2, wherein the region of channels comprises linear U-channels formed in the interior surface of the wooden head.

6. The composite barrel of claim 2, wherein the wooden head includes wooden planks.

7. The composite barrel of claim 6, wherein the wooden planks are at least partially comprised of an oak wood.

8. The composite barrel of claim 1, wherein the exterior surface of the wooden head comprises a region of channels.

9. The composite barrel of claim 1, wherein the sealing mechanism comprises:
an annular flange on the open end of the polymer body, the annular flange having an interior surface;
an outer ring connectable with the interior surface of the annular flange for seating the wooden head;
an inner ring nestable in the outer ring against an exterior surface of the wooden head; and
an attachment mechanism for securing the inner ring to the polymer body and sealingly securing the wooden head with the polymer body.

10. The composite barrel of claim 9, further comprising rivets securing said outer ring to said annular flange, said rivets having an internal bore, the inner ring comprising a series of apertures therethrough, each aperture positioned to correspond with the internal bore of each rivet when the inner ring is nested in the outer ring in a position for sealing the wooden head with the polymer body and the inner ring is secured to the outer ring by insertion of a fastener through the aperture into the internal bore of the rivet; and an annular seal between the wooden head and the outer ring.

11. The composite barrel of claim 9, further comprising rivets securing said outer ring to said annular flange, said rivets having an internal bore, the inner ring comprising a series of slanted slots therethrough, each slanted slot positioned to correspond with the internal bore of each rivet when the inner ring is nested in the outer ring, the inner ring being secured to the outer ring by insertion of a fastener through the aperture into the internal bore of the rivet, the slanted slots angled such that rotation of the inner ring relative to the outer ring compresses the wooden head against the polymer body and seals the wooden head to the polymer body; and an annular seal between the wooden head and the outer ring.

12. The composite wine barrel of claim 9, wherein the inner ring comprises a lower depending interior annular lip for contacting the wooden head; the outer ring comprises a depending interior annular lip for seating the wooden head; and the flange comprises an interior annular lip for seating the outer ring.

13. The composite wine barrel of claim 11, wherein the slanted slots comprise a serrated portion for gripping the fastener.

14. The composite barrel of claim 1, wherein the polymer body further comprises a further open end and the composite barrel further comprising a further wooden head attachable to the further open end of the polymer body.

15. The composite barrel of claim 1, further comprising a stainless steel insert for at least partially lining the polymer body.

16. A wooden head for use with a composite barrel for storing a liquid, the wooden head comprising:
an interior surface contactable with the liquid and an exterior surface; and
a plurality of channels formed on the interior surface to increase surface area for contact with the liquid.

17. The wooden head of claim 16, wherein the channels comprise cross-hatch channels.

18. The wooden head of claim 16, wherein the channels comprise linear T-channels.

19. The wooden head of claim 16, wherein the channels comprise linear U-channels.

20. The wooden head of claim 16, wherein the wooden head includes wooden planks.
